(19) United States
(12) Patent Application Publication
(10) Pub. No.: US 2019/0215402 A1
(43) Pub. Date: Jul. 11, 2019

(54) Integrated mobile application server and communication gateway

(71) Applicant: SHOPTEXT, INC., New York, NY (US)

(72) Inventors: Mark Mitchell Kaplan, New York, NY (US); Colin Rand, New York, NY (US)

(21) Appl. No.: 16/241,652

(22) Filed: Jan. 7, 2019

Related U.S. Application Data
(63) Continuation of application No. 11/125,833, filed on May 10, 2005, now abandoned.

(51) Int. Cl. H04M 15/00; H04L 29/08; G06Q 20/12; H04W 4/24; G06Q 20/32; H04M 17/00; H04L 12/14

(52) U.S. Cl. CPC H04M 15/00; H04M 2215/7826; G06Q 20/12; H04W 4/24; G06Q 20/123; G06Q 20/32; H04M 17/00; H04M 15/8221; H04M 15/68; H04M 15/52; H04L 12/14; G06Q 20/3276; G06Q 20/322; H04M 2215/0196; H04M 2215/28; H04L 67/04

(57) ABSTRACT

A system is provided that includes a request module adapted to receive a request from an initiation interface initiated by a user and a user profile module adapted to associate the request with a user profile of the user. The user profile includes at least a payment plan selected by the user and an identification number of the user. The system also includes a payment interface adapted to submit a payment demand to the payment plan and a mobile communication interface adapted to transmit a confirmation to a mobile communication network for transmission to a wireless device associated with the identification number. In the system, the initiation interface may be a wireless device, a magnetic swipe reader, a wireless barcode reading device, an RFID interface, a website, and/or a web banner interface. A method of operating a server is provided. A computer-readable storage medium containing a set of instructions for a processor is provided.

### FIELD OF THE INVENTION

The present invention relates to wireless devices. More particularly, the present invention relates to an integrated mobile application server and communication gateway, and a method of operating an integrated application server and communication gateway.

### BACKGROUND

The internet is a significant venue for retail sales. Some internet transactions are made using a credit card, and some transactions are made using an alternative payment scheme, for instance PayPal. Banner ads on websites may be used to generate interest in an internet retail purchase opportunity.

Radio frequency ID (RFID) tags may be used for tracking stock or other items (for instance, packages), and operate by passing the item in the region of a scanner. The scanner creates an electromagnetic field which interacts with the RFID tag causing the RFID tag to emit a radio signal. The radio signal emitted by the RFID tag may give various information, including a serial number indicating the identity of the item that has just been scanned.

RFID systems are conventionally used in supply chain management to track inventory, retail environments to enhance merchandise security, and at retail locations to initiate credit card payments.

An alternative identification system is the barcode system, which is composed of a symbol (for instance, a barcode) printed on the exterior of an item that is adapted to be read by a barcode reader, which may consist of a laser for reflecting off the barcode and a reader for receiving and interpreting the reflected image. Barcodes may be visually encoded numbers which are used to track inventory and identify products for most consumer packaged goods environments.

A magnetic strip reading system is used by swiping a magnetic strip past a reader and is conventionally used in credit card readers.

Mobile telephones are conventional, as are mobile phone originated SMS (Short Message Service) signals. SMS signals conventionally include a text message.

Optical character recognition (OCR) systems are currently used to extract text from images and are widely used in document management and document archival systems.

Interactive voice recognition (IVR) systems are phone based voice driven programs currently used in call support centers to provide customer assistance in making purchases and technical support.

Web banners are traditional display advertisements adapted to the World Wide Web to allow for interactive capabilities.

E-commerce Web Stores are product catalogues that have been adapted to the World Wide Web and enable product browsing and purchasing to create interactive shopping experiences.

Backend systems within the mobile and wireless communications industries are fragmented and incompatible. The fragmentation and system incompatibility within these markets makes seamless consumer communications and brand marketing cost prohibitive and functionally impractical. Conventionally, mobile operating systems communicate promotional content and information, without the ability to detect the user handset or integrate into 3rd party databases or systems. Current systems do not enable the purchasing of physical product, billing via premium SMS or integration into commercial databases, nor do they allow dynamic manipulation of their mobile content

These systems are distinct and have not been integrated to provide users with a seamless, convenient and efficient shopping experience. Thus, a need exists to integrate technology to provide a more efficient shopping experience.

### SUMMARY OF THE INVENTION

The present invention provides an integrated mobile application server (IMAS) system adapted to integrate a consumer experience, corporate operations and brand communications across web, mobile, wireless, physical spaces and traditional media. The IMAS system enables commercial purchasing, user-profiling and community building using a mobile or wireless network as the initiating transaction vehicle and/or as the method of confirming a transaction.

Additionally, the present invention provides for billing the mobile carrier's phone bill, as well as allowing mobile and wireless transactions to be captured via PayPal, credit card, redemption of pre-paid transactions and/or crediting consumer databases/loyalty programs. Likewise, the present invention provides for initiating transactions through banners, web applications, physical spaces via RFID, magnetic swipe and optical image recognition as well as traditional mobile originated Standard Rate SMS and Premium SMS. Furthermore, IMAS can be integrated with commercial fulfillment and product catalog registries for the authentication, payment, credit and fulfillment of physical products and commercial services.

The present invention integrates independent systems to create a viable consumer experience and commercial system in a cross communication environment. The system enables a consumer to interact with a single system seamlessly moving across different communication channels receiving medium specific messages, purchasing material goods, services, content, and/or crediting a loyalty account or consumer profile.

This exemplary system enables connectivity and integration between mobile telecommunications and wireless internet networks with product inventory and fulfillment databases, customer loyalty programs/databases, retail and commercial operating systems, eCommerce fulfillment systems and other such transactional or operational IP-based systems; in a manner that is seamless to the consumer.

A system is provided that includes a request module adapted to receive a request from an initiation interface initiated by a user and a user profile module adapted to associate the request with a user profile of the user. The user profile includes at least a payment plan selected by the user and an identification number of the user. The system also includes a payment interface adapted to submit a payment demand to the payment plan and a mobile communication interface adapted to transmit a confirmation to a mobile communication network for transmission to a wireless device associated with the identification number.

In the system, the initiation interface may be a wireless device, a magnetic swipe reader, a wireless barcode reading device, an RFID interface, a website, and/or a web banner interface.

In the system, the wireless communication interface may be adapted to submit the request in the form of an SMS message, an EMS message, an MMS message, a wireless web upload, an email, and/or a WAP mini site link.

In the system, the payment plan may be a credit card, a debit card, a prepaid card, and/or an internet-based payment plan.

The system may further include an order fulfillment module adapted to receive the request from the request module and send the request to an order fulfillment center.

In the system, the request may be for a consumer article, a consumer service, a credit to a loyalty program, and a media download.

The system may further include a data mining module, a reporting module, a handset identification module, and/or a content management module.

The system may further include a loyalty system and/or a transaction record database.

In the system, the confirmation may be adapted to prompt a response from the user to authorize the request and the payment demand, adapted to communicate to the user the request and the payment demand, and/or an IVR interface adapted to obtain at least one datum from the user. In the system, the at least one datum may be a size datum, a color datum, and/or a style datum.

The system may further include a download module adapted to send data to the wireless communication network for downloading to the wireless device.

In the system, the wireless device includes a mobile phone, a mobile phone including a camera, a personal digital assistant, and a WIFI-enabled mobile handset. A method of operating a server is provided that includes receiving at the server a selection from a purchase interface by a user and accessing by the server a user profile including at least a payment plan selected by the user and an identification number of the user. The method also includes requesting by the server an authorization from a wireless device associated with the identification number, the wireless device being operated by the user.

The method may further include submitting a payment demand to the payment plan.

The method may further include, if the authorization is sent by the user to the server, performing a downloading of data from the server to the wireless device, submitting a fulfillment request to a fulfillment center for sending a consumer article to the user, and/or crediting a loyalty program associated with the user.

In the method, the purchase interface may be the wireless device, a magnetic swipe reader, a wireless barcode reading device, an RFID interface, a website, and/or a web banner interface.

The method may further include performing an interactive voice response dialogue with the user to determine at least one datum from the user.

A computer-readable storage medium containing a set of instructions for a processor is provided. The set of instructions includes receiving at the server a selection from a purchase interface by a user and accessing by the server a user profile including at least a payment plan selected by the user and an identification number of the user. The method also includes requesting by the server an authorization from a wireless device associated with the identification number. The wireless device is operated by the user. The computer-readable storage medium may further include, if the authorization is sent by the user to the server, performing a downloading of data from the server to the wireless device, submitting a fulfillment request to a fulfillment center for sending a consumer article to the user, and crediting a loyalty program associated with the user. The computer-readable storage medium may further include submitting a payment demand to the payment plan.

These and other features and aspects of the present invention will be better understood with reference to the following figures and detailed description.

### BRIEF DESCRIPTION OF THE FIGURES

FIG. 1 illustrates an RFID system.

FIG. 2 illustrates RFID as a security enhancement.

FIG. 3 illustrates RFID as a payment initiator.

FIG. 4 illustrates an OCR system as a document archiving tool.

FIG. 5 illustrates a barcode reader as a product identification tool.

FIG. 6 illustrates a web banner.

FIG. 7 illustrates diagrammatically a portion of an Integrated Mobile Application Server (IMAS) according to an exemplary embodiment of the present invention.

FIG. 8 illustrates diagrammatically another portion of an Integrated Mobile Application Server (IMAS) according to an exemplary embodiment of the present invention.

FIG. 9 illustrates diagrammatically a further portion of an Integrated Mobile Application Server (IMAS) according to an exemplary embodiment of the present invention.

FIG. 10 illustrates an exemplary IMAS system with RFID.

FIG. 11 illustrates an exemplary IMAS system with an OCR system and a barcode system.

FIG. 12 illustrates an exemplary IMAS system with an image processing system.

FIG. 13 illustrates an exemplary IMAS system with an IVR system.

FIG. 14 illustrates an exemplary IMAS system with web banners.

FIG. 15 illustrates an exemplary IMAS system with eCommerce.

FIG. 16 illustrates an exemplary IMAS system with Web-based Instant Messaging (IM).

FIG. 17 illustrates an exemplary IMAS system with Global Positioning System (GPS).

FIG. 18 illustrates an exemplary IMAS system with a broadcast system.

FIG. 19 illustrates an exemplary IMAS system using SMS to purchase physical products or commercial services.

### DETAILED DESCRIPTION

The present invention relates generally to the field of mobile (GSM, CDMA, TDMA, 3G, EVDO, etc. . . . ) and wireless (Wi-Fi, Wi-Max, etc. . . . ) communications. More specifically, the present invention is related to the development of a fully integrated system for processing, distributing and routing communications between IP and telecommunications systems. The system provides interactive consumer experiences and brand communications across Internet, Mobile, Wireless, Physical Spaces and Traditional marketing to enable commerce and community building functionality.

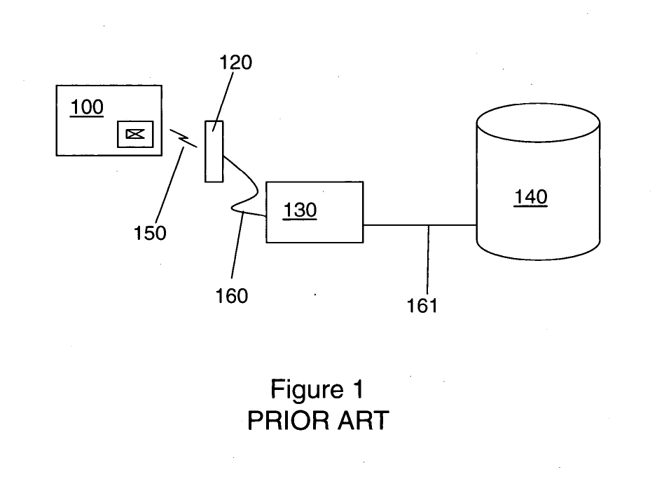

FIG. 1 illustrates an RFID system used to track inventory. In FIG. 1, RFID-enabled card 100 may be placed on an article being tracked. RFID signal reader 120 may be coupled to local data server 130 by network 160, which may in turn be coupled to central data repository 140 over network 161. The sequence of action may begin as RFID-enabled card 100 passes within range of the field for RFID signal reader 120. This may trigger RFID signal 150 including the data stored in the embedded chip in RFID-enabled card 100 to RFID signal reader 120. Next, RFID signal reader 120 may pass the collected data to local data server 130. Local data server 130 may then pass the data with any additional relevant information along network 161 to by network 160, which may in turn be coupled to central data repository 140. This type of system is may be used to track shipments of goods entering and leaving warehouses.

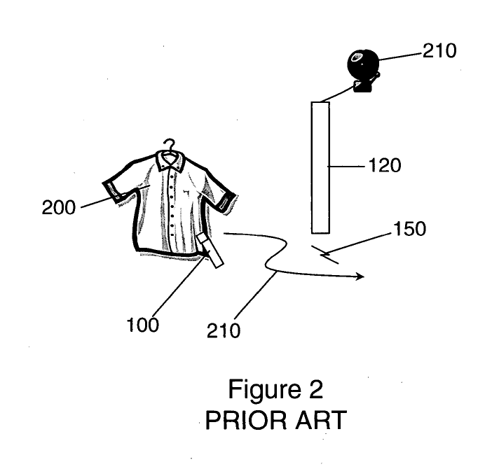

FIG. 2 illustrates RFID as a security enhancement of a retail operation. Article 200 is a retail item with RFID-enabled card 100 attached as an RFID tag. RFID signal reader 120 is coupled to alarm 210. The sequence of action in this scenario begins when article 200 passes within range of RFID signal reader 120, which senses whether RFID-enabled card 100 is active or not. If RFID-enabled card 100 is active, then RFID signal reader 120 signals to alarm 210 to sound. This mechanism may be found in retail environments where the RFID tags are placed on the merchandise being sold.

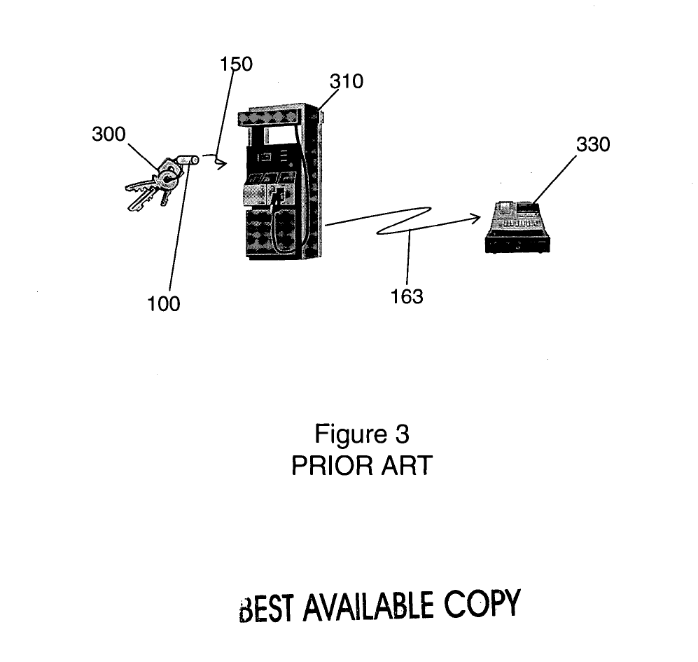

FIG. 3 illustrates RFID being used to initiate a payment. Personal item 300, for instance keys, may include RFID-enabled card 100. Vending kiosk 310, for instance a gas pump, may be embedded with an RFID reader and may be coupled by network 163 to cash register 330. The sequence of events in this scenario begins when personal item 300 passes within range of the RFID reader embedded in vending kiosk 310. At that point, RFID-enabled card 100 passes payment information to the RFID card reader including details matching the consumer possessing personal item 300 to a credit account. This information is passed from vending kiosk 300 via network 163 to cash register 330. Cash register 330 may communicate with a credit card payment system and may record the transaction. This mechanism may be found at gas stations and other quick pay environments.

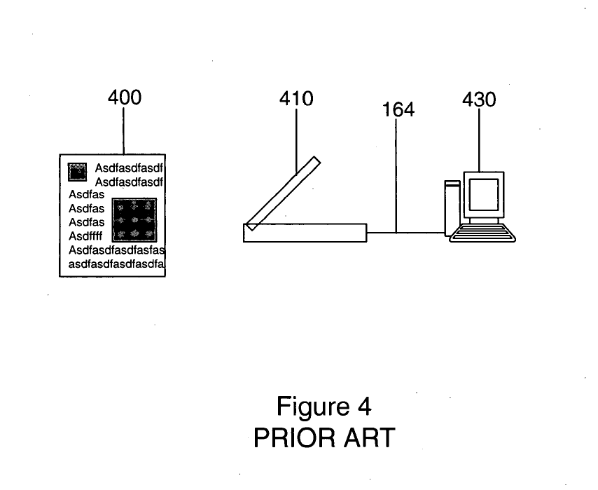

FIG. 4 illustrates using an OCR system with a digital document archiving system. Document 400 includes characters which are to be entered into the digitizing system. Optical scanner 410 is coupled by network 164 to computer system 430 that analyzes document 400 and stores it for archiving. The method begins when document 400 is scanned and translated to a digital format. The digital data is sent from optical scanner 410 via network 164 to computer system 430 for analysis. Computer system 430 may extract the text from document 400, which may be stored in an indexed system for later retrieval.

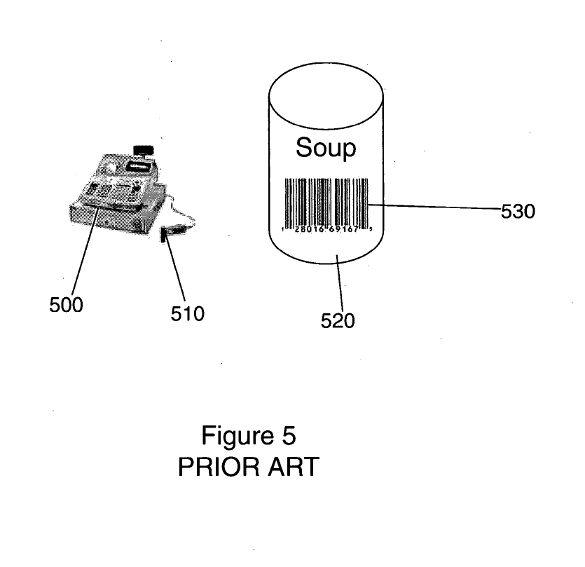

FIG. 5 illustrates the components in a bar code system that is used to identify products. Cash register 500 coupled to barcode scanner 510. Barcode scanner 510 reads barcode 530 on product 530, which results in a unique code that cash register 500 can use to price product 530. This system may be found in retail environments in order to assist in centralized pricing systems and/or inventory systems.

An Interactive Voice Response (IVR) system may be a network that provides interactive voice response via telephone systems. The customer may interact with a computer which has voice recognition software, thereby enabling the system to follow a script walking the customer through a series of interactions. The system may provide purchase support for consumers.

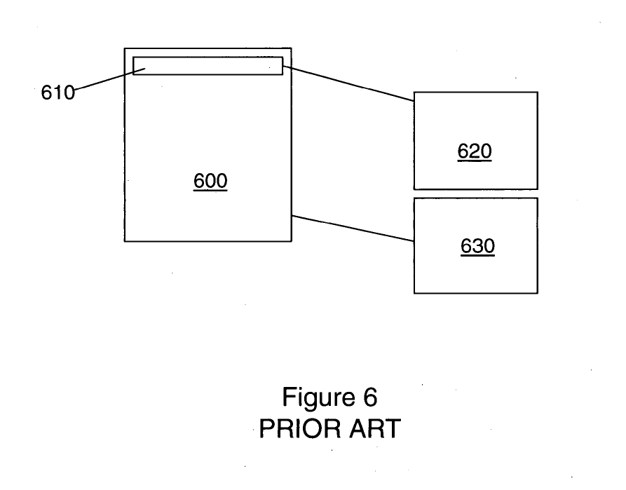

FIG. 6 illustrates a web-based banner advertisement system. Online banner advertisement 610 included in web page 600 faces the consumer 1. Server 620 hosts banner advertisement 610 and controls its display. Web server 630 hosts web page 600 and the associated website that the consumer is viewing. The basic scenario begins with the consumer requesting web page 610 from the web site hosted by web server 630. Upon receiving web page 600, the consumer's web browser is instructed to download banner advertisement 610 from server 620.

An eCommerce system may allow a user to visit an eCommerce enabled web site in order to shop for goods and services. On the eCommerce website, special applications may support the consumer shopping experience, such as a shopping card. One part of the eCommerce system is the integration with a payment gateway which may allow the consumer to pay the retailer with a credit card, and to provide the authorization and capture of funds by the retailer without physical interaction between the retailer and consumer.

Integrated Mobile Application Server (IMAS) 700 according to an exemplary embodiment of the present invention may include data mining module 701 that enables the reporting of activity by cross referencing certain fields of information within other modules in the system. Content management module 702 may assign identification and instructional information to content assets. Asset hosting module 703 may host content assets like text, images, audio files, video clips and other like content. WAP mini-site module 704 may host WAP pages for wireless web browsing. User profile module 705 may store the users profile with mobile number, purchasing history and/or other such preferences. OCR/barcode module 706 may read, translate and/or process alpha/numeric characters and/or barcodes. Handset detect module 707 may detect the model of the user's wireless handset. Authentication module 708 may systematically communicate with the consumer to confirm and ensure that the user of a certain wireless phone number and/or device ID desires the requested transaction, thereby confirming the purchase and/or transaction. Transaction manager 709 may queue the requested purchase until the user authenticates the purchase and billing is approved. Image processing module 710 may read, translate and/or process visual images. Image manipulation module 711 may enable users to dynamically alter their mobile visual content into customized assets by, for instance, adding text to a still image. Product/catalog reference ID module 712 may store the information that identifies each unique merchant, the supplementary information that is gathered from the user, and/or appropriate routing information to fulfill orders.

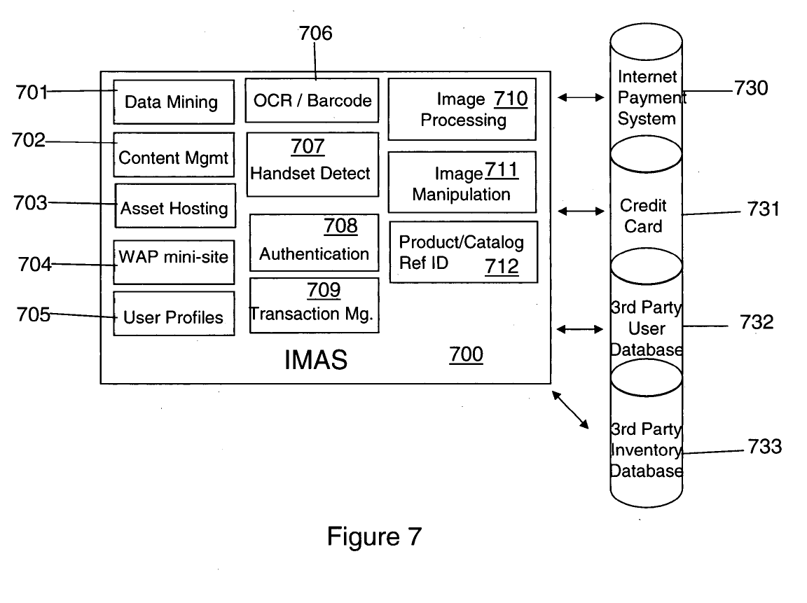

FIG. 7 illustrates diagrammatically a portion of IMAS 700 according to an exemplary embodiment of the present invention. IMAS 700 may be coupled by a network to any or all of Paypal 730, credit card system 731, 3^{rd} party user database 732, and 3^{rd} party inventory database 733. Additionally, IMAS 700 may be networked with any other appropriate payment method and/or any other appropriate fulfillment center, including product shipping warehouses and/or loyalty programs.

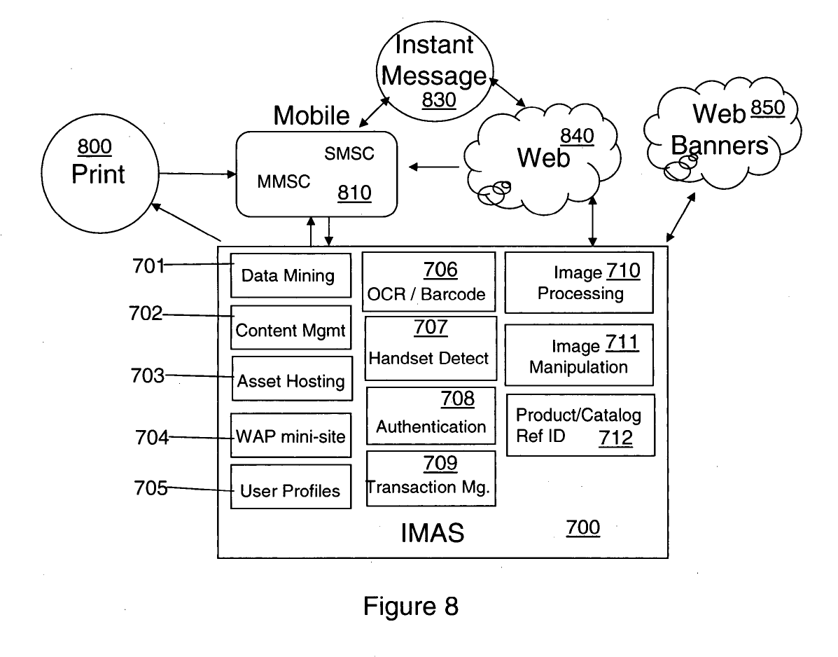

FIG. 8 illustrates diagrammatically another portion of IMAS 700 according to an exemplary embodiment of the present invention. IMAS 700 may be coupled by a network to any or all of print system 800, SMSC/MMSC system 810, web system 840 and web banner system 850. An instant message system may be coupled to web system 840 as well as SMSC/MMSC system 810.

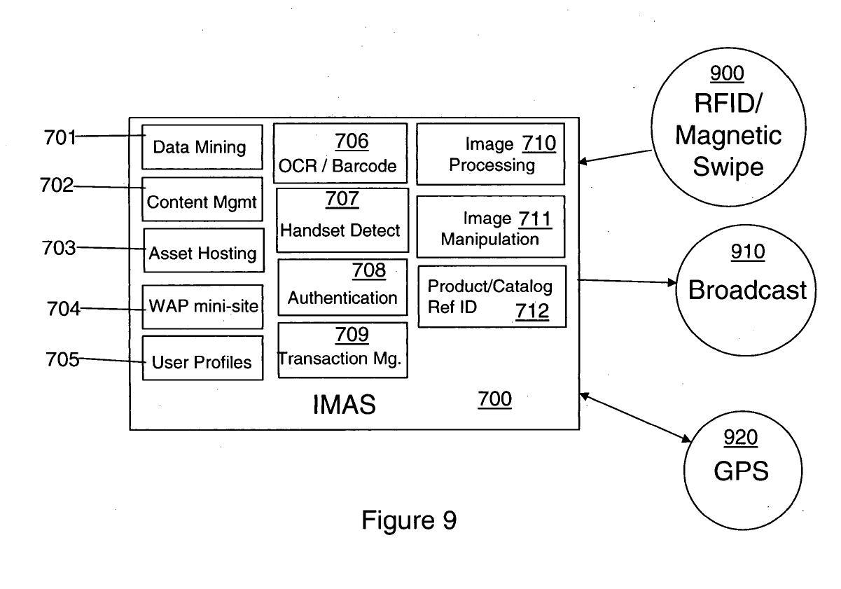

FIG. 9 illustrates diagrammatically a further portion of IMAS 700 according to an exemplary embodiment of the present invention. IMAS 700 may be coupled by a network to any or all of RFID/magnetic swipe system 900, broadcast system 910, and/or global positioning system (GPS) 920.

There are several external communication interfaces by which the integrated system is able to interact with in order to provide the seamless experience for consumers. These interfaces include internet, mobile, print, RFID and magnetic swipe, GPS, and broadcast. Additionally, IMAS interacts with each of these interfaces via two-way channels illustrated in the diagram.

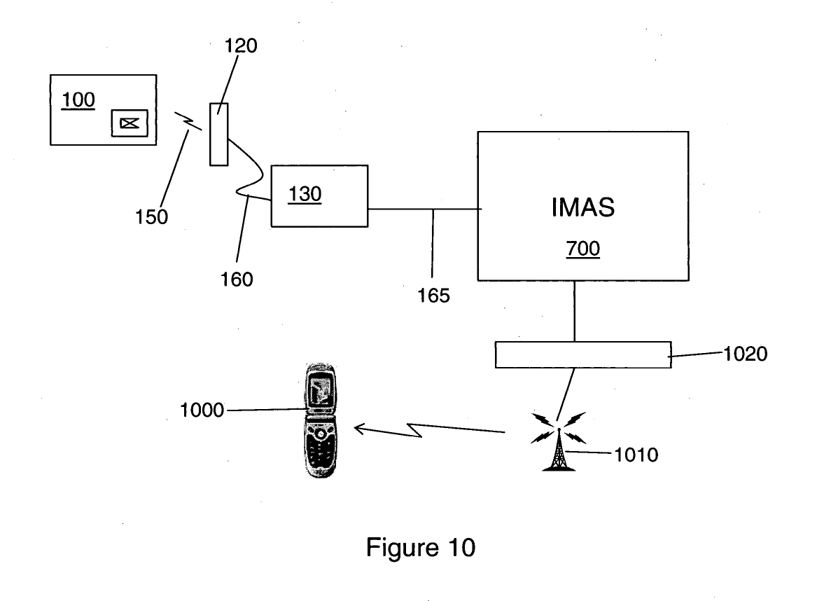

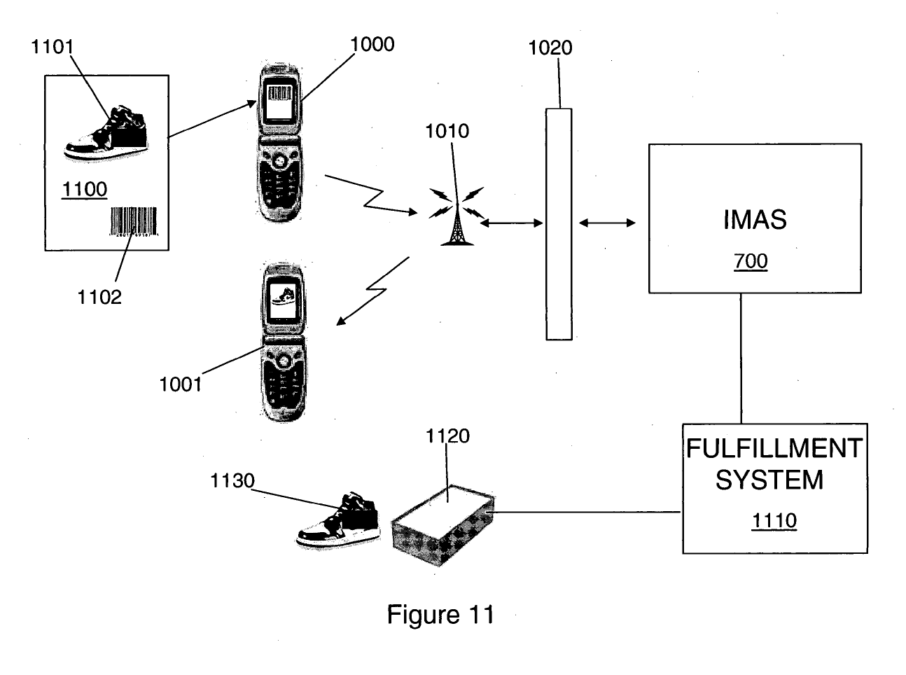

FIG. 10 illustrates an exemplary embodiment of the present invention with RFID. RFID-enabled card 100 is adapted to be read by RFID signal reader 120, which may be coupled to local data server 130 by network 160. Local data server 130 may be coupled by network 165 to IMAS 700, which may be coupled to mobile gateway 1020. Mobile gateway 1020 may alternatively be a messaging gateway including a gateway for all types of messages including Wi-Fi. Mobile gateway 1020 may couple to mobile communication network 1010, which may couple wirelessly to wireless device 1000, which may be for example a consumer mobile phone. Mobile communication network 1010 may be any type of mobile carrier or ISP network, and may be adapted to accommodate for Wi-Fi/Wi-Max phones and/or devices. The process may begin when RFID-enabled card 100 passes within range of RFID signal reader 120 causing RFID-enabled card 100 to emit RFID signal 150, which may include data stored in the embedded chip in RFID-enabled card 100, to RFID signal reader 120. RFID signal reader 120 may send the unique identification code to local data server 130. Next, local data server 130 communicates via network 165 to transmit the unique identification and any additional information necessary in order to identify the location of local data server 130 to IMAS 700. With the unique identification number, IMAS 700 looks up the corresponding mobile phone number in a database and/or look-up table in a user profile module of IMAS 700. IMAS 700 then sends multimedia content to mobile gateway 1020. Mobile gateway 1020 may send the multimedia content to the correct mobile communication network 1010 for transmission to wireless device 1000, which may be the consumer's mobile phone. This system may be used for loyalty cards and location based activation of marketing campaigns. Additionally or alternatively, IMAS 700 may transmit an SMS message to wireless device 1000 to authorize a sale transaction initiated by the present of RFID-enabled card 100 being within reading presence of RFID signal reader. This sale may be for an article to be shipped via a fulfillment center to a user. FIG. 11 illustrates an exemplary embodiment of the present invention with OCR and barcode scanning technologies. Printed illustration 1100 includes barcode 1102, product image 1101, and/or a textual description of an article, for instance shoes. Wireless device 1000 includes an embedded camera, and may be, for instance, a consumer mobile phone. Mobile communication network 1010 couples to mobile gateway 1020, which couples to IMAS 700. IMAS is coupled to fulfillment system 1110 which stocks, tracks, and ships package 1120 including consumer product 1130.

This method begins with a consumer taking a photograph with their camera phone (wireless device 1000) of barcode 1102 embedded in printed illustration 1100 poster of consumer product 1130. Next, the consumer sends the photograph via mobile communication network 1010, which passes via mobile gateway 1020 to arrive at IMAS 700. IMAS 700 then uses barcode recognition software to extract the product identifier, and/or OCR to extract any textual instructions from the photograph. The mobile phone number detected from the transmission from wireless device 1000 is used to lookup a user profile stored in IMAS 700. Using the preferred consumer payment method, IMAS 700 may charge the cost of the product to the specified consumer account. Once payment authorization is received, IMAS 700 may send confirmation of the purchase to the consumer, via mobile gateway 1020 and mobile communication network 1010, which may then be received by wireless device 1001, which may be the wireless device displaying an image of the product. Concurrently, IMAS 700 may send instructions to fulfillment system 1110 to have package 1120 including product 1130 shipped to the address of record in the user's profile stored in the user profile module of IMAS 700. This system can be used to enable retailers to sell physical goods at locations where the retailer has no infrastructure. Alternatively, the exemplary method may used to vend multimedia content for mobile phones for which there is no physical product component, for example ringtones.

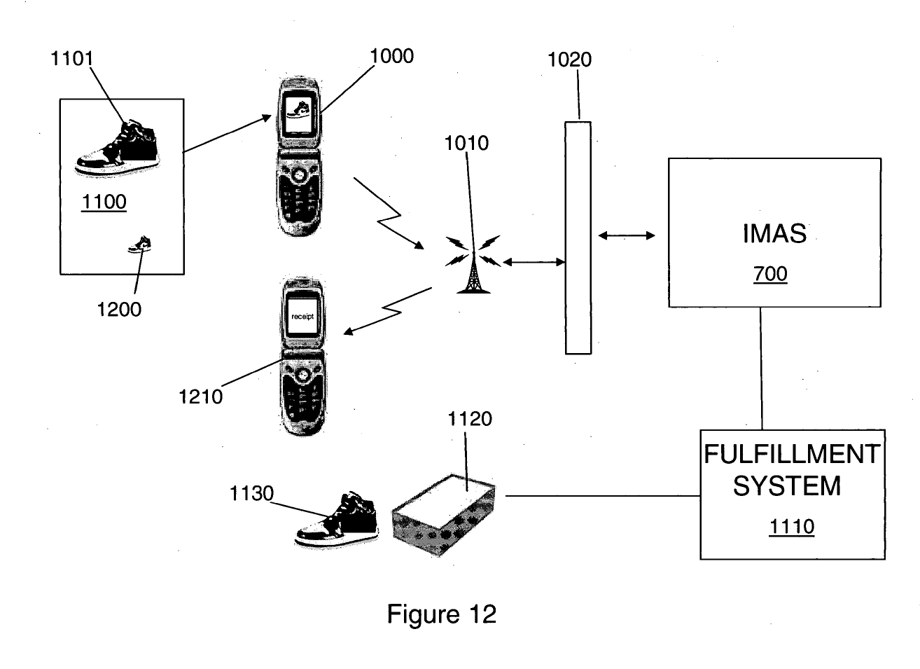

FIG. 12 illustrates an exemplary embodiment of the present invention with Image processing. Printed illustration 1100 includes pictorial icon 1200, product image 1101, and/or a textual description of an article, for instance shoes. Wireless device 1000 includes an embedded camera, and may be, for instance, a consumer mobile phone. Mobile communication network 1010 couples to mobile gateway 1020, which couples to IMAS 700. IMAS is coupled to fulfillment system 1110 which stocks, tracks, and ships package 1120 including consumer product 1130.

This method begins with a consumer taking a photograph with their camera phone (wireless device 1000) of pictorial icon 1200 embedded in printed illustration 1100 poster of consumer product 1130. Next, the consumer sends the photograph via mobile communication network 1010, which passes via mobile gateway 1020 to arrive at IMAS 700. IMAS 700 then uses image processing software to match the product to a known product and OCR to extract any textual instructions from the photograph. The mobile phone number detected from the transmission from wireless device 1000 is used to lookup a user profile stored in IMAS 700. Using the preferred consumer payment method, IMAS 700 may charge the cost of the product to the specified consumer account. Once payment authorization is received, IMAS 700 may send confirmation of the purchase to the consumer, via mobile gateway 1020 and mobile communication network 1010, which may then be received by wireless device 1003, which may be the wireless device displaying a receipt for the product. Concurrently, IMAS 700 may send instructions to fulfillment system 1110 to have package 1120 including product 1130 shipped to the address of record in the user's profile stored in the user profile module of IMAS 700. This system can be used to enable retailers to sell physical goods at locations where the retailer has no infrastructure. Alternatively, the exemplary method may used to vend multimedia content for mobile phones for which there is no physical product component, for example ringtones.

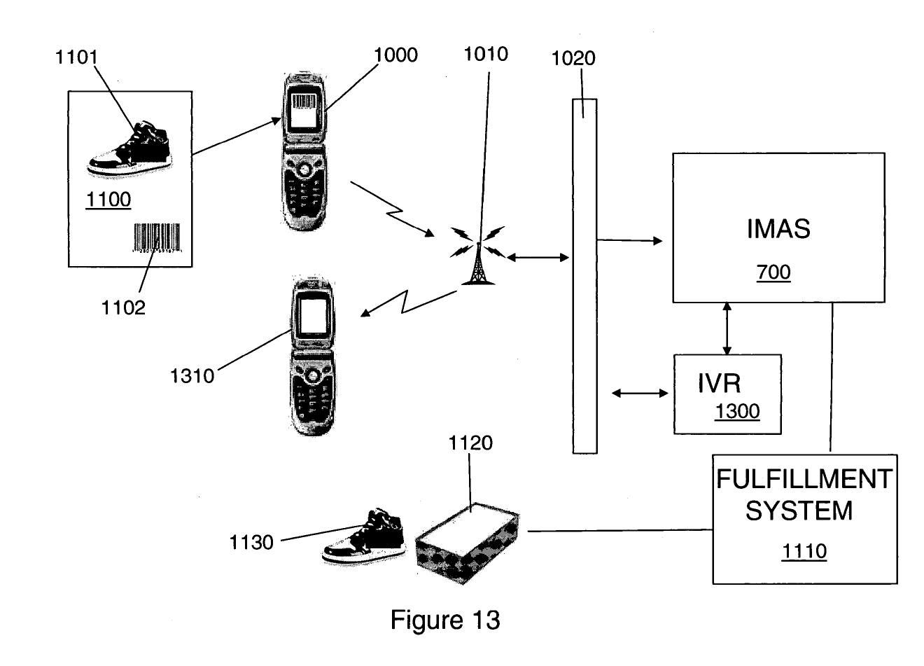

FIG. 13 illustrates an exemplary embodiment of the present invention with IVR. Printed illustration 1100 includes barcode 1102, product image 1101, and/or a textual description of an article, for instance shoes. Wireless device 1000 includes an embedded camera, and may be, for instance, a consumer mobile phone. Mobile communication network 1010 couples to mobile gateway 1020, which couples to IMAS 700. IMAS is coupled to fulfillment system 1110 which stocks, tracks, and ships package 1120 including consumer product 1130. IMAS 700 is also coupled to IVR system 1300.

This method begins with a consumer taking a photograph with their camera phone (wireless device 1000) of barcode 1102 embedded in printed illustration 1100 poster of consumer product 1130. Next, the consumer sends the photograph via mobile communication network 1010, which passes via mobile gateway 1020 to arrive at IMAS 700. IMAS 700 then uses barcode recognition software to extract the product identifier, and/or OCR to extract any textual instructions from the photograph. The mobile phone number detected from the transmission from wireless device 1000 is used to lookup a user profile stored in IMAS 700.

Upon identification of consumer product 1130, IMAS 700 instructs IVR system 1300 to initiate an automated call to the consumer via mobile gateway 1020 and mobile communication network 1010 to wireless device 1003. IVR system 1300 then performs an interactive voice response process with the consumer via wireless device 1003 that can collect additional information about the desired purchase, such as, but not limited to, size, configuration, or color choices for the product. Upon completion of the IVR session, IMAS 700 receives from IVR system 1300 any additional instructions collected from the consumer and processes the transaction.

Then, using the preferred consumer payment method, IMAS 700 may charge the cost of the product to the specified consumer account. Once payment authorization is received, IMAS 700 may send confirmation of the purchase to the consumer, via mobile gateway 1020 and mobile communication network 1010, which may then be received by wireless device 1003. Concurrently, IMAS 700 may send instructions to fulfillment system 1110 to have package 1120 including product 1130 shipped to the address of record in the user's profile stored in the user profile module of IMAS 700. This system can be used to enable retailers to sell physical goods at locations where the retailer has no infrastructure. Alternatively, the exemplary method may used to vend multimedia content for mobile phones for which there is no physical product component, for example ringtones.

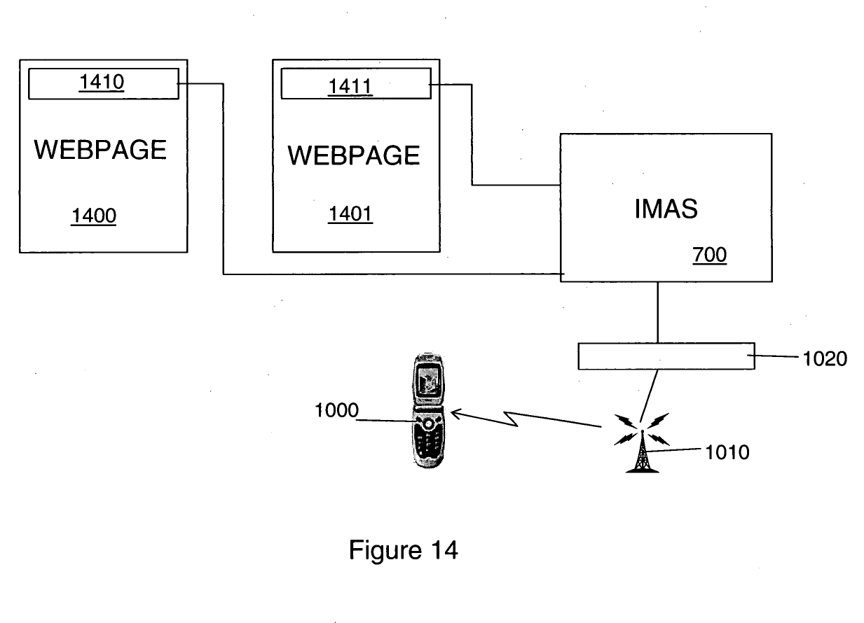

FIG. 14 illustrates an exemplary embodiment of the present invention with web banners. Web page 1400 includes banner ad 1410, while web page 1401 includes post-transactional banner ad 1411. IMAS 700 is coupled to banner ad 1410, post-transactional banner ad 1411, and mobile gateway 1020. Mobile gateway 1020 couples to mobile communication network 1010, which communicates wirelessly with wireless device 1000.

In this scenario, a consumer browses web page 1400 having banner ad 1410. Banner ad 1410 is an online advertisement offering the immediate purchase of a product by having the consumer enter their mobile phone number into a form on the advertisement. The product may be either physical or multimedia. The consumer then submits the information relating to the desired purchase which is transmitted to IMAS 700. In response, IMAS 700 sends a confirmation of the purchase and alters the image displayed in the banner advertisement so that web page 1401 displays post-transactional banner ad 1411. Next, IMAS 700 identifies the desired payment method from the user profile, processes the payment, and transmits the confirmation and multimedia product to the consumer through mobile gateway 1020 to mobile communication network 1010 to wireless device 1000. Alternatively, the method above may be used to purchase a consumer article by coupling IMAS 700 to a fulfillment center for sending a product to the consumer.

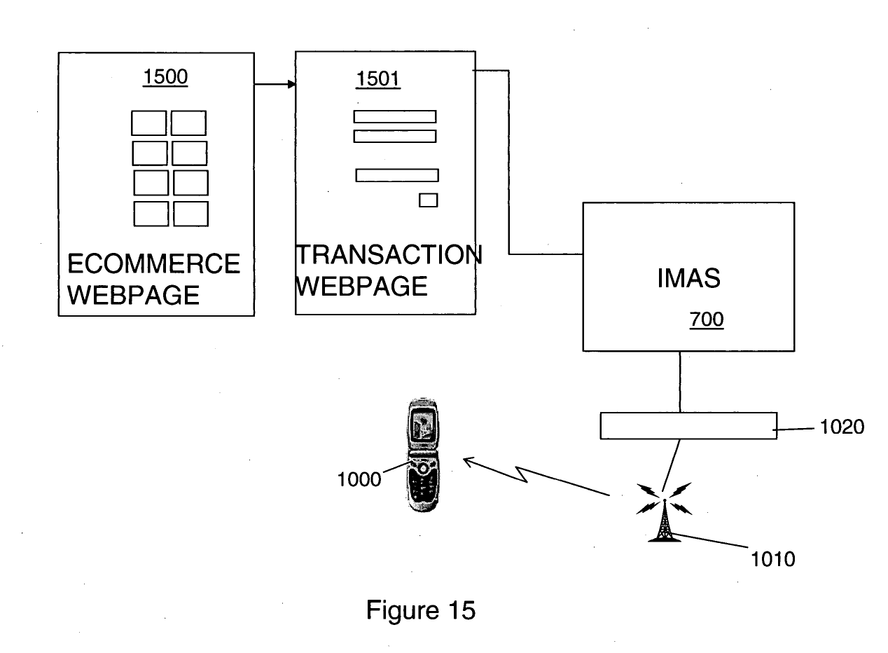

FIG. 15 illustrates an exemplary embodiment of the present invention with eCommerce web stores and web sites. A user may enter main webstore website 1500, sign in, and enter transactional page 1501. Once the user confirms their purchase on transaction page 1501 and submits the request, the request is passed to IMAS 700. IMAS 700 processes the request, transacts the purchase and passes the content and/or confirmation of the purchase through mobile gateway 1020 to mobile communication network 1010 to wireless device 1000.

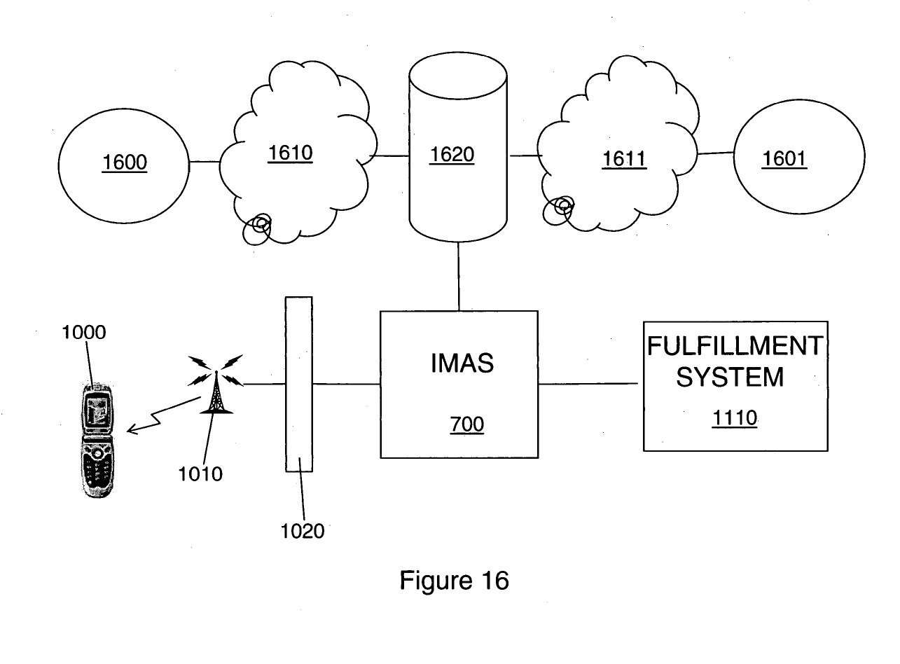

FIG. 16 illustrates an exemplary embodiment of the present invention with IM. IM user A 1600 communicates with IM user B 1601 by sending a text communication over Web 1610 to web server 1620, which processes and communicates the communication via Web 1611 to IM User B 1601. In this process, if mobile content (e.g. a ringtone) or a transaction (e.g. purchase of a consumer article) were desired by either user, web server 1620 would process keywords or requests in the transcript between the IM clients and transmit the request with a user ID to IMAS 700. IMAS 700 processes the request and, if the request was for mobile content, IMAS 700 would transact the purchase and pass the content or confirmation of purchase to mobile gateway 1020 onward to mobile communication network 1010 and on to wireless device 1000. If the request was for a commercial product or service, IMAS 700 would transact the purchase and pass the fulfillment order to fulfillment system 1110 for fulfillment.

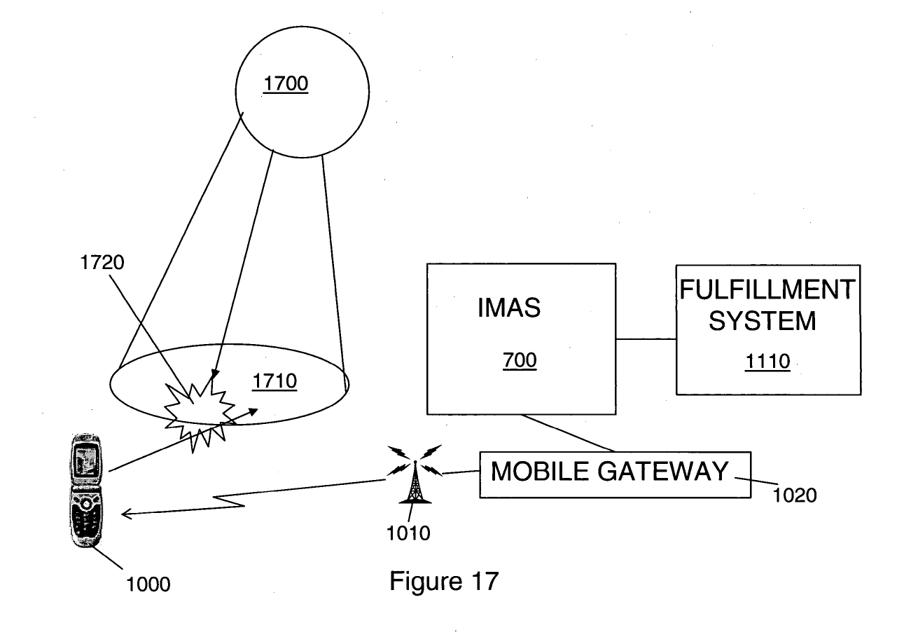

FIG. 17 illustrates an exemplary embodiment of the present invention using GPS. GPS System 1700 provides positioning information to GPS-enabled wireless device 1004, which is programmed to recognize when it is positioned in a purchase initiation area 1710. As device 1004 enters area 1710 at point 1720, device 1004 initiates a communication to IMAS 700 via mobile communication network 1010 and mobile gateway 1020. After IMAS 700 identifies the consumer and the account and processes the payment, IMAS 700 sends confirmation to device 1004 of the purchase as well as an order to fulfillment center 1110 to ship the product or provide the service.

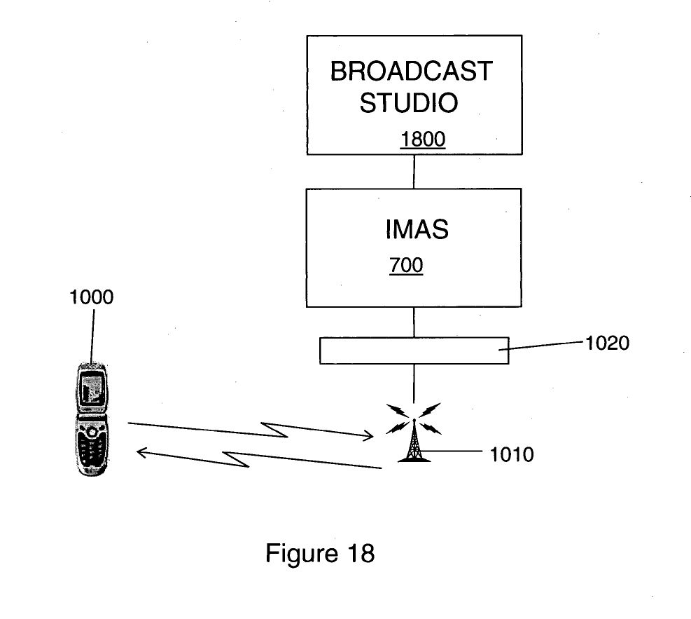

FIG. 18 illustrates an exemplary embodiment of the present invention with a broadcast system. The user initiates a communication with mobile device 1000 via mobile carrier network 1010), which is connected to the mobile gateway 1020. Mobile gateway 1020 passes the data to IMAS 700, where the submission is processed. Once the data is processed, IMAS may send a confirmation of the purchase to mobile device 1000. IMAS 700 may also send the appropriate graphic, text or other resulting asset is output by IMAS 700 and delivered on a dedicated connection to broadcast studio 1800. The user may purchase any type of broadcast by the system displayed in FIG. 18, including pay-per-view, play-on-demand, and a digital recording of a broadcast, for example TiVo.

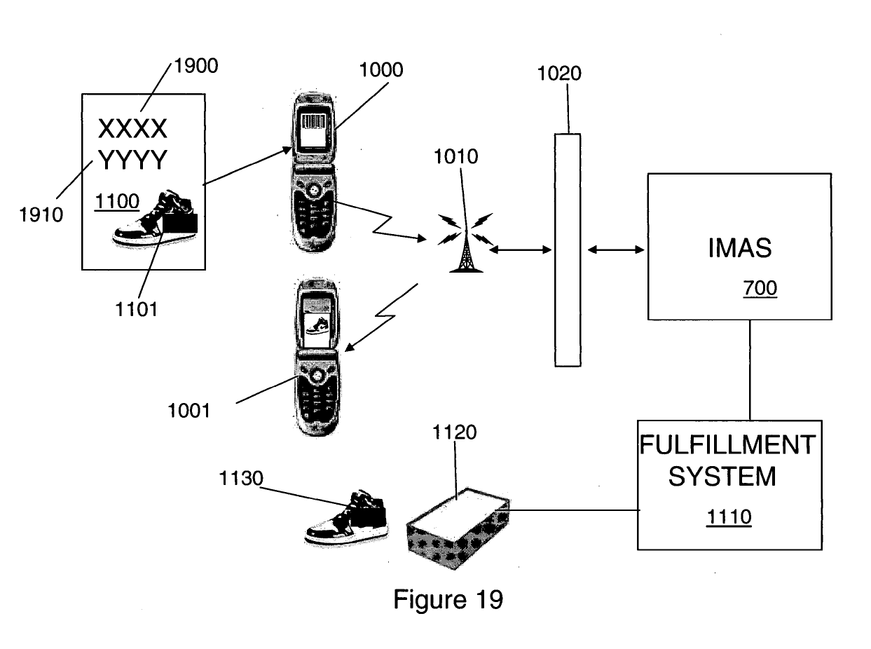

FIG. 19 illustrates an exemplary embodiment of the present invention using SMS to purchase physical products or commercial services. Printed illustration 1100 includes a product or service representational image 1101 along with a character combination for destination identification 1201 and character combination for product identification 1202. Also shown in FIG. 19 is mobile communication network 1010 coupled to mobile gateway 1020, which is coupled to IMAS 700. IMAS is coupled to fulfillment system 1110 which stocks, tracks, and ships package 1120 including consumer product 1130.

This method begins with a consumer entering text message destination characters 1201 into the ‘TO’ field and the product identification characters 1202 into the message body field on wireless device 1000. The user would then initiate a communication via mobile communication network 1010 which is connected to 1020 The messaging gateway 1020 passes the data to IMAS 700 where the submission is processed.

IMAS may detect from the transmission from wireless device 1000 the mobile phone number and lookup a user profile stored in IMAS 700. Using the preferred consumer payment method, IMAS 700 may charge the cost of the product to the specified consumer account. Once payment authorization is received, IMAS 700 may send confirmation of the purchase to the consumer, via mobile gateway 1020 and mobile communication network 1010, which may then be received by wireless device 1001, which may be the wireless device displaying an image of the product. Concurrently, IMAS 700 may send instructions to fulfillment system 1110 to have package 1120 including product 1130 shipped to the address of record in the user's profile stored in the user profile module of IMAS 700.

The Integrated mobile application server has a payment interface comprised of credit cards, an internet-based payment system (for instance, Paypal) and carrier billing components. Each of these components allow for the consumer to pay for goods, services, and the consumer's preferred billing mechanism is stored in their user profile. When used in conjunction with the RFID interface, this embodiment allow for consumers to activate purchasing of mobile content from interacting with a physical space.

When used in conjunction with the OCR, Barcode, and Image processing components, the payment component allows the consumer to make payments for goods and services by taking a snapshot with a digital camera and sending the photograph to IMAS.

When used in conjunction with the IVR interface, the payment component allows for consumers to complete their transactions by submitting payment for their desired goods and services.

When used in conjunction with the web banners component, the payment component allows for consumers to complete purchases initiated from the banner advertisements, based on their stored preferences.

The Integrated mobile application server has a loyalty program component by which marketing programs can be run which allow for consumers to accrue rewards points. These points are accumulated according to a marketing promotional plan.

When used in conjunction with the RFID interface, the loyalty program can grant consumers points when they attend an event or visit a physical space. When the consumer's loyalty card is enabled with RFID, each time they pass an IMAS RFID reader, they can receive rewards points.

When used in conjunction with the OCR, Barcode, and Image processing components, the loyalty program can grant consumers points. When the consumer sends in a photograph to IMAS, IMAS can grant points according to the subject matter included in the photograph, determined by the OCR, Barcode and image processing components.

When used in conjunction with the Web banner component, a consumer can be granted rewards points for activating the form embedded in the IMAS enabled banner ad. For example, a consumer viewing a banner ad for a product can enter their phone number to receive a coupon on their mobile phone. In addition, by using the IMAS interface, they can receive rewards points as well.

Currently companies provide some solutions discussed in this invention as stand-alone components without the means of communicating or transmitting data to and from the consumer; or the stand-alone component is not connected to a support component, or the systems do not have any method processing a commercial transaction, thus making the system impractical for commercial use. Even for those systems that do have premium SMS billing, this method is very expensive for the content provider because of the carrier's mark up and the cost to route a billing code into their mainframe. Additionally, premium SMS transactions may be capped at $4.99. This system provides the option to businesses to bill for products and services or pay for material goods on PayPal, Credit Cards and/or pre-paid redemption in addition to Premium SMS.

The major system components include mobile messaging and connectivity, mobile asset hosting, WAP mini sites (which are scaled down websites with reduced graphics to allow easier access by a mobile device), data mining, reporting and content management.

The system includes subcomponents that will drive loyalty programs and process consumer transactions, manage user profiles, perform mobile authentication, manage mobile download queues, automate mobile handset detection, barcode image processing and manage consumer subscriptions.

The web banner interface provides a mechanism by which consumers browsing the internet may opt in to mobile programs or purchase mobile products from within a banner ad. The interaction with the banner ad does not require that the consumer leave the host website that they are currently browsing.

The interface will connect the banner ads with the transaction server, which then manages the request and appropriately links the ad with one of the transaction server major or sub components.

The web interface provides a mechanism by which consumers can browse web sites that will interact with mobile programs. This interaction may include downloading programs to a mobile device. Such actions that consumers may participate in would be web stores for online products, opt in for mobile programs, sign up for mobile subscription services, or other similar activities.

The web interface provides for a custom look and feel to be created for the particular campaign while allowing for the reuse of the internal transaction server major and sub components.

The RFID interface provides a mechanism by which the transaction server receives messages directly or via an intermediate server connected to an RFID reader. The RFID reader is able to transmit unique, encrypted consumer identifications to the transaction server to indicate the consumer's participation in a given mobile campaign. The participation could include registration for a mobile program, purchase of a mobile product, or some other similar feature. Alternatively, instead of an RFID reader, a magnetic swipe reader could be seamlessly interchanged.

The credit card interface allows the transaction server to place credits and debits on major credit cards via a credit card processing gateway.

The PayPal interface allows the transaction server to place credits and debits using the PayPal service.

The mobile messaging and connectivity component will provide the interfaces to SMSC, WAP Push and MMSC systems. Each of these systems is connected to a mobile phone interoperability and messaging system that provides cross carrier messaging. Additionally, this mobile connectivity component provides the interface for the premium billing capabilities for mobile messaging. This component also provides the link to the WAP gateway for mobile web browsing.

The mobile asset hosting component provides mobile phones access to the mobile content that has been requested. Upon receiving a WAP Push message the consumer will follow an embedded link to the mobile content. This content will only be available for a limited number of downloads and a limited time.

In addition to images and applications, other types of multimedia assets will be available for download through the system. These can be audio or video, either clips of streaming.

The WAP mini sites component will support building dynamic content for WAP Push mobile programs. Such programs will enable the content to change on a regular basis without need to send a new message to the content user.

The data mining component will provide an interface to extract usage reports enabling the analysis of consumer behavior. The data extracted to provide access to content usage by region, carrier, or additionally collected consumer demographic information.

The reporting component will provide standardized reports on the activity and performance of each campaign. Additionally, reports will be available on particular usage statistics. Transaction reconciliation reports will be utilized to determine content or other partnership distributions amounts.

The mobile content manager provides an administrative interface to update content for the mobile campaigns. The content will be available for the given handset classes specified by the handset detection component, and made available through the various interfaces, either web, WAP site, WAP Push or MMS.

The system will track user participation in mobile programs in order to create reward programs.

The system will connect the web, web banner, and RFID/magnetic swipe interfaces with the credit card and PayPal billing interfaces in order to complete consumer purchases.

The system will create a universal consumer profile which connects the user's unique mobile phone number with their purchasing preferences, credit card information, subscriptions, and purchase history.

The system will utilize an authentication component that will be used to send a SMS message to a consumer's phone requiring them to reply in order to confirm that they are in possession of the mobile phone.

The system will utilize a download queue so that when a consumer initiates a purchase; their mobile download will not be sent, but rather queued for delivery, waiting for the completion of the mobile authentication.

The system will utilize a handset detection component that will recognize the type of handset upon receipt of the SMS authentication. Based on the handset type and mobile product in the download queue, the resulting mobile content will be optimized for the target handset device specifications.

The system will utilize a component that will manage and maintain subscription services for consumers. This will enable consumers to opt in for daily, weekly, and monthly programs without having to opt in or approve each transaction individually. Consumers will have charges placed automatically through the transaction management component.

The system will use the gifting and bundling component to allow for consumers to send mobile products as gifts to other consumers and downloading of multiple mobile products at a single time.

The dynamic image manipulation component will allow for mobile products to be customized in real time to allow for personalized messages to be included in the mobile product. Such messages could be names or short quotes that would become embedded in an image. The image would then be pushed back to the consumer or sent to another consumer in conjunction with the gifting and bundling component.

The images that receive the message could be gif, jpeg, png, flash or other visual medium which a mobile phone is capable of displaying either natively or through a custom application or internet browser.

The barcode image processing component will allow for the consumer to take a photograph with their mobile phone of a barcode and submit the image as a picture message, MMS or other similar transmission protocol, and be received and processed by the transaction server. This processing will interpret the barcode using OCR to extract a product identification number, and by associating the mobile phone number with the product identification number, complete the purchase by integrating with the transaction manager.

Additional text can be included with the submitted image for further instructions as to how the transaction should be handled. For example, text could refer to bidding instructions for an auction, where the item up for auction is identified by the barcode. This component can be used in conjunction with the mobile authentication to allow for one consumer to initiate a purchase by photographing a barcode, and once received by the IMAS system send a message to another mobile user requiring their approval before completing the transaction.

Building on the barcode image processing component, the image processing component will allow for iconography other than barcodes to be used for identifying a product. For example, the consumer would take a photograph of an icon representing a shoe which would then be associated with a particular product, and the image processing component would interpret the icon and associate it with the designated product in order to complete the transaction.

A custom interface can be developed that would allow for integration between the integrated mobile application server (IMAS) and an IVR system. This interface would support two basic modes of operation: initiating an IVR session via mobile activation and initiating a mobile download from an IVR session.

Initiating an IVR session via mobile activation would begin with a consumer taking a snapshot with their mobile phone of a PayPal/IMAS enabled barcode. This image would then be sent to the IMAS which would process the product request. In order to complete the transaction, the IMAS would contact with the IVR system through this interface to initiate a session with the consumer. The consumer would use IVR system to verify their purchase and add additional processing information such as shipping address or specifying other instructions such as product sizes. During the transaction, the IVR would query IMAS product catalog for additional information as needed Initiating a mobile download from IVR session would begin during an IVR session when a consumer requests mobile product or a mobile receipt for the purchase. This would result in the IVR system beginning a notification to IMAS which sends message with product or receipt to mobile phone number on record for given account.

FIG. 1 shows an exemplary system according to the present invention. Element 10 is a server, also referred to herein as an integrated mobile application server and communication gateway. Server 10 includes an authorization and queue application, a loyalty application, a transaction database, and a database of user profiles. Alternatively or additionally, Server 10 may access another server or other memory for any or all of these functions or features. Server 10 access may be accessed by a web interface, for instance a web banner interface. For example, a user may input a mobile phone number in a web banner as a method of initiating a purchase of a mobile device download, for instance a ringtone, game, picture, video, or other download. Inputting the mobile phone number may access a previously formed account identified by the mobile phone number. The account may include billing information. In the event that no previously formed account for the inputted mobile phone number exists, the web interface may direct the user to set-up an account, by for instance creating a new web interface or redirecting the existing web interface.

The user may set up an account by inputting personal information, a mobile phone number or numbers, personal preferences, and/or payment information. Payment information may be any of credit card information, Paypal or another appropriate web-based payment system, and/or a mobile telecommunication billing plan.

After the user inputs the mobile phone number in the web banner or other web interface, and after the mobile phone number is associated with an existing account, server 10 associates the authorization with the requested download in a queue. Server 10 would then send an SMS message to the mobile phone to confirm the purchase and download and thereby confirm that the person inputting the information in the web banner interface is the owner of the phone and the person listed in the user profile. The SMS message would require a response, which may be simply a reply, a simple affirmative response (e.g., “yes”), and/or may be a response including a personal identification number.

After the authorizing response, server 10 would send the download to the mobile device and would complete the billing to the selected payment plan. Additionally, server 10 would also log the transaction in a transaction database and/or input the purchase into a loyalty program to assist in future marketing efforts directed at the consumer. The row of connections on the top of FIG. 1 represent connections between server 10 and a mobile device. Included are WAP mini sites, asset hosting (which may represent a mobile telecommunication company, a mobile barcode, and a MMS, WAP push, or SMS messaging service. In particular, the mobile barcode may allow the user of a mobile phone, in which the mobile phone has a picture-taking capability, to take a picture of a barcode and send the picture to server 10. The user would also authorize server 10 to complete a purchase of the item having the barcode. The purchase may be fulfilled through an online retailing system operated in conjunction with server 10 and/or through another online retailer. Server 10 may access a user profile and/or a billing selection when a mobile device sends a picture image of a barcode in this manner. Connecting to server 10 from the bottom of FIG. 1 is an arrow leading out of server 10 to a data mining and reporting box, which indicates a reporting function that leverages information in any of the user profile component, the loyalty component, and/or the transaction component of server 10 for the preparation of a report. A data mining or other report prepared in this manner may be useful for marketing, planning, or any other business function.

An arrow leading into server 10 in FIG. 1 represents the input of content to server 10, which may include photos, ringtones, games, videos, and/or any other appropriate download for a mobile device.

The RFID interface for server 10 may provide a location-based download for a user having an RFID which is associated with a user profile, user account, and/or payment plan. The user may initiate a purchase by arranging the RFID in proximity to an RFID interface (for instance a scanner/reader). The RFID interface may then initiate the purchasing operation by sending the unique RFID tag and selected item to server 10. The remainder of the purchasing operation may proceed in the same manner as the purchasing operation described above in the context of a web interface.

Additionally, the present invention provides for an article of manufacture comprising computer readable program code contained within implementing one or more modules to aid in the purchase of mobile content download initiated from an interactive web advertisement. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, -EPROM, RAM, ROM, DRAM, SRAM, SDRAM, or any other appropriate static or dynamic memory or data storage devices.

The above enhancements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of wireless applications and web-based programming.

This application discusses specific embodiments of the present invention. The specific features described herein may be used in some embodiments, but not in others, without departing from the spirit and scope of the invention as set forth in the foregoing disclosure. It will be appreciated by those of ordinary skill in the art that the illustrative examples do not define the metes and bounds of the invention. For example, the present invention should not be limited by software/program, computing environment, or specific computing hardware.

What is claimed is:

1. A system comprising:
a request module adapted to receive a request from an initiation interface initiated by a user;
a user profile module adapted to associate the request with a user profile of the user, the user profile including at least a payment plan selected by the user and an identification number of the user;
a payment interface adapted to submit a payment demand to the payment plan; and
a mobile communication interface adapted to transmit a confirmation to a mobile communication network for transmission to a wireless device associated with the identification number.

2. The system of claim 1, wherein the initiation interface is at least one of:
the wireless device;
a magnetic swipe reader;
a wireless barcode reading device;
an RFID interface;
a website; and
a web banner interface.

3. The system of claim 1, wherein the wireless communication interface is adapted to submit the request in the form of at least one of:
an SMS message;
an EMS message;
an MMS message;
a wireless web upload;
an email; and
a WAP mini site link.

4. The system of claim 1, wherein the payment plan is at least one of a credit card, a debit card, a prepaid card, and an internet-based payment plan.

5. The system of claim 1, further comprising an order fulfillment module adapted to:
receive the request from the request module; and
send the request to an order fulfillment center.

6. The system of claim 1, wherein the request is for at least one of:
a consumer article;
a consumer service;
a credit to a loyalty program; and
a media download.

7. The system of claim 1, further comprising at least one of a data mining module, a reporting module, a handset identification module, and a content management module.

8. The system of claim 1, further comprising at least one of:
a loyalty system; and
a transaction record database.

9. The system of claim 1, wherein the confirmation is at least one of:
adapted to prompt a response from the user to authorize the request and the payment demand;
adapted to communicate to the user the request and the payment demand; and
an IVR interface adapted to obtain at least one datum from the user.

10. The system of claim 9, wherein the at least one datum is at least one of a size datum, a color datum, and a style datum.

11. The system of claim 1, further comprising a download module adapted to send data to the wireless communication network for downloading to the wireless device.

12. The system of claim 1, wherein the wireless device includes at least one of:
a mobile phone;
a mobile phone including a camera;
a personal digital assistant; and
a WIFI-enabled mobile handset.

13. A method of operating a server, comprising:
receiving at the server a selection from a purchase interface by a user;
accessing by the server a user profile including at least a payment plan selected by the user and an identification number of the user; and
requesting by the server an authorization from a wireless device associated with the identification number, the wireless device being operated by the user.

14. The method of claim 13, further comprising submitting a payment demand to the payment plan.

15. The method of claim 13, further comprising, if the authorization is sent by the user to the server, performing at least one of:
downloading data from the server to the wireless device;
submitting a fulfillment request to a fulfillment center for sending a consumer article to the user; and
crediting a loyalty program associated with the user.

16. The method of claim 13, wherein the purchase interface is at least one of:
the wireless device;
a magnetic swipe reader;
a wireless barcode reading device;
an RFD interface;
a website; and
a web banner interface.

17. The method of claim 13, further comprising performing an interactive voice response dialogue with the user to determine at least one datum from the user.

18. A computer-readable storage medium containing a set of instructions for a processor, the set of instructions comprising:
receiving at the server a selection from a purchase interface by a user;
accessing by the server a user profile including at least a payment plan selected by the user and an identification number of the user; and
requesting by the server an authorization from a wireless device associated with the identification number, the wireless device being operated by the user.

19. The computer-readable storage medium of claim 18, further comprising, if the authorization is sent by the user to the server, performing at least one of:
downloading data from the server to the wireless device;
submitting a fulfillment request to a fulfillment center for sending a consumer article to the user; and
crediting a loyalty program associated with the user.

20. The computer-readable storage medium of claim 18, further comprising submitting a payment demand to the payment plan.
